(19) United States
(12) Patent Application Publication
(10) Pub. No.: US 2025/0159336 A1
(43) Pub. Date: May 15, 2025

(54) Efficient Camera System and Method

(71) Applicant: Mediatek Inc., Hsinchu City (TW)

(72) Inventors: Chi-Cheng Ju, Hsinchu City (TW); Yan-Shao Liu, Hsinchu City (TW); Yu-Chang Huang, Hsinchu City (TW); Chih-Hung Wu, Hsinchu City (TW)

(21) Appl. No.: 18/948,548

(22) Filed: Nov. 15, 2024

Related U.S. Application Data
(60) Provisional application No. 63/598,983, filed on Nov. 15, 2023.

(51) Int. Cl. H04N 23/60; H04N 23/667

(52) U.S. Cl. CPC H04N 23/64; H04N 23/665; H04N 23/667

(57) ABSTRACT

A method for a camera system includes generating, by a processor, a set of control parameters for an image sensor to capture a first image frame. The set of control parameters correspond to at least one capture setting. The method further includes determining, by the processor, whether a change in the at least one capture setting has occurred since capturing the first image frame. A first subsequent image frame is captured using the set of control parameters for the first image frame when no change in the at least one capture setting has occurred.

### CROSS REFERENCE TO RELATED APPLICATIONS

This application claims the benefit of U.S. Provisional Application No. 63/598,983, filed on Nov. 15, 2023. The content of the application is incorporated herein by reference.

### BACKGROUND

Modern digital cameras, whether standalone or integrated into smartphones and other devices, rely heavily on sophisticated software systems to control image capture and processing. These camera software systems are designed to manage various aspects of image acquisition, including exposure control, focus adjustment, white balance, image stabilization, High Dynamic Range (HDR) processing, and noise reduction. Traditionally, these systems operate on a frame-by-frame basis, continuously adjusting parameters for each captured image or video frame. This approach aims to ensure optimal image quality by responding quickly to changes in scene conditions or user inputs.

### SUMMARY

An embodiment provides a method for a camera system. The method comprises generating, by a processor, a set of control parameters for an image sensor to capture a first image frame, wherein the set of control parameters correspond to at least one capture setting, determining, by the processor, whether a change in the at least one capture setting has occurred since capturing the first image frame, wherein a first subsequent image frame is captured using the set of control parameters for the first image frame when no change in the at least one capture setting has occurred.

An embodiment provides a camera system comprising a processor coupled to an image sensor. The processor is used to generate a set of control parameters for the image sensor to capture a first image frame, wherein the set of control parameters correspond to at least one capture setting. The processor is used to determine whether a change in the at least one capture setting has occurred since capturing the first image frame, wherein a first subsequent image frame is captured by the image sensor using the set of control parameters for the first image frame when no change in the at least one capture setting has occurred.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a simplified diagram of a related frame-by-frame control camera system.

FIG. 2 depicts a simplified diagram of a non-frame-by-frame control camera system according to the embodiments.

FIG. 3 depicts the non-frame-by-frame control camera system of FIG. 2 with demonstration of changes in capture settings and frame results.

FIG. 4 depicts a flow diagram of a method for adaptive image capture in the camera system of FIG. 2.

FIG. 5 depicts another non-frame-by-frame control camera system according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

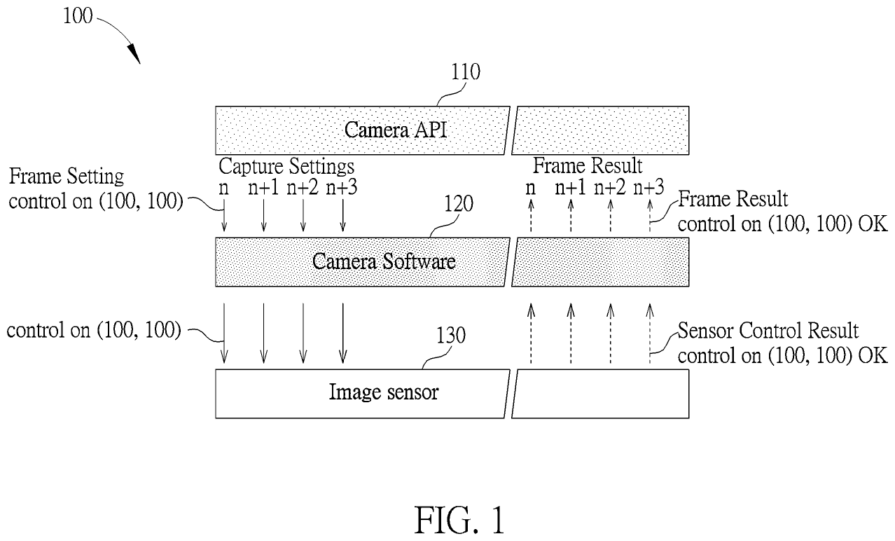

FIG. 1 depicts a simplified diagram of a related frame-by-frame control camera system 100. The frame-by-frame control camera system 100 is an approach used in digital camera software to manage image capture. In camera system 100, camera API (Application Program Interface) 110, camera software 120 and an image sensor 130 are illustrated. The camera API 110 serves as the high-level control interface sending capture settings. The camera software 120 (e.g., driver, middleware) exerts precise control over each individual frame captured by the sensor. For every single frame, the camera software 120 goes through a complete cycle of settings adjustment, capture, and processing. This approach aims to achieve the highest level of control and adaptability in image capture. The image sensor 130 is the physical hardware capturing images.

In this approach, the process begins with sending capture settings for each consecutive frame (n, n+1, n+2, n+3, and so on) from the camera API 110. For every single frame, the camera software 120 applies specific control settings—for instance, control on position (100, 100) for frame n+1. These control settings are then transmitted to the image sensor 130, which executes the frame setting and captures the frame accordingly. After capture, the image sensor 130 provides feedback, confirming the result (in this case, “control on position (100, 100) is OK”) for the corresponding frame result of frame n+1. This entire sequence—from setting calculation to control application to result confirmation—repeats continuously for each frame, allowing for precise control but potentially leading to redundant calculations and increased CPU load, especially when capture conditions remain stable across multiple frames.

The image sensor 130 is a component in cameras and other imaging devices that converts light into electronic signals. It includes an array of photosensitive elements, known as pixels, which capture light and convert it into electrical charges. These charges are then processed to form a digital image. There are two main types of image sensors: CCD (Charge-Coupled Device) and CMOS (Complementary Metal-Oxide-Semiconductor). The performance of an image sensor is influenced by factors such as pixel size, sensor size, and the technology used, all of which contribute to the clarity, resolution, and overall quality of the captured images.

The frame-by-frame control approach is highly responsive to changes in the scene or user input, ensuring each frame is optimized using the latest data. However, this method requires constant recalculation, which is computationally intensive and results in higher power consumption. Additionally, in stable conditions, this can lead to potential redundancy, as many calculations may become unnecessary.

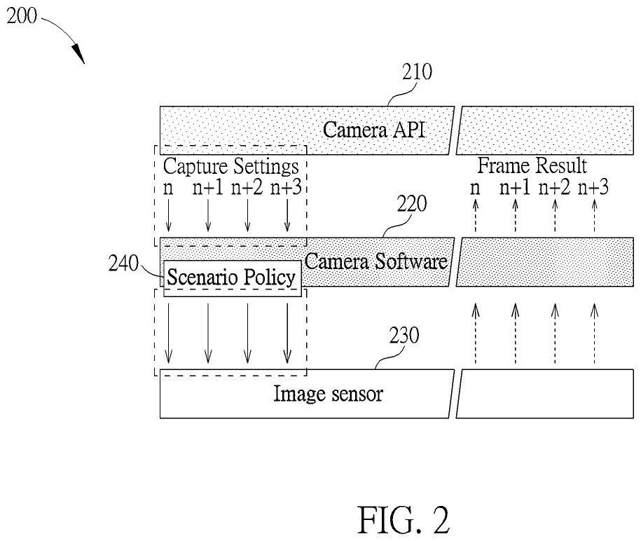

FIG. 2 depicts a simplified diagram of a non-frame-by-frame control camera system 200 according to the embodiments. The non-frame-by-frame control camera system 200 represents an alternative approach to related camera software control methods. For some embodiments, the core components in the non-frame-by-frame control camera system are similar to those in frame-by-frame systems For example, a camera API 210 may serve as the high-level interface, camera software 220 may manage the capture logic, and the image sensor 230 may perform the actual image capture. However, the key difference lies in how control settings are applied and when results are processed, which can be implemented by a scenario policy 240 in the camera software 230.

The scenario policy 240 can monitor for significant changes in at least one of the capture settings, such as user-controlled capture conditions (e.g., zoom factor, exposure settings) and/or capture environment (e.g., ambient lighting conditions, scene content). The scenario policy 240 determines when a recalculation of control parameters is necessary based on the capture settings, triggering updates only when meaningful changes occur in capture settings. Such changes might include user-controlled adjustments like zoom factor or exposure settings, or environmental shifts that could require adaptations like switching to HDR capture mode.

In further detail, the scenario policy 240 employs a monitoring mechanism to optimize camera performance and resource usage. This mechanism focuses on a set of critical capture settings, which may include elements such as exposure time, ISO sensitivity, focus distance, and zoom factor. These settings are constantly observed for any changes that might necessitate a recalculation of control parameters.

The monitoring process involves two key comparison methods: threshold comparison and relative change comparison. In threshold comparison, each monitored capture setting is associated with one or more predetermined thresholds. These thresholds represent significant points at which the recalculation of control parameters is necessary. For example, there might be an ISO threshold above which a different noise reduction algorithm becomes necessary. In relative change comparison, relative changes in capture settings are tracked. It compares current values against previous ones, looking for deviations that exceed specified amounts. This method can catch gradual changes that might not trigger a threshold but still require recalculation of control parameters.

When the monitoring process detects that at least one of the capture settings has either exceeded its corresponding predetermined threshold or deviated from its previous value by more than the specified amount, it triggers a recalculation event. This event prompts the system to reassess and update the entire set of control parameters. The recalculation process takes into account not just the changed setting, but how this change might affect other interdependent parameters. For instance, a significant change in exposure time might require adjustments to ISO sensitivity and noise reduction parameters as well.

By implementing this nuanced monitoring and recalculation approach, the system ensures that it maintains optimal image quality and performance while minimizing unnecessary computational overhead. It strikes a balance between being responsive to meaningful changes in capture conditions and avoiding the inefficiency of constant recalculations.

The efficiency of the non-frame-by-frame control camera system 200 lies in its selective recalculation approach. By only updating control parameters when necessary, it significantly reduces CPU usage and power consumption compared to related frame-by-frame systems. For instance, a single control command (such as “control on position (100, 100)”) can be applied across multiple frames, from Frame n to Frame n+3, without the need for frame-by-frame recalculation.

It is important to note that while the software control operates on this optimized, non-frame-by-frame basis, the hardware (e.g., image sensor 230) interaction often still requires frame-by-frame control. This hybrid approach allows the system to maintain precise hardware control while benefiting from the efficiency of less frequent software updates.

The completion of control results in the camera system 200 occurs at variable time points, affecting multiple subsequent frames. This flexibility allows the system to adapt to different scenarios efficiently while still providing the option for more precise control when needed. In stable capture conditions, the system reuses previously calculated parameters, only recalculating and applying new control parameters when the Scenario Policy detects a significant change.

Overall, the non-frame-by-frame control camera system 200 strikes a balance between the high precision of related frame-by-frame control and the efficiency of less frequent updates. By reducing unnecessary recalculations while maintaining responsiveness to significant changes, this approach optimizes system performance, reducing CPU load and power consumption without compromising on the ability to adapt to changing capture conditions.

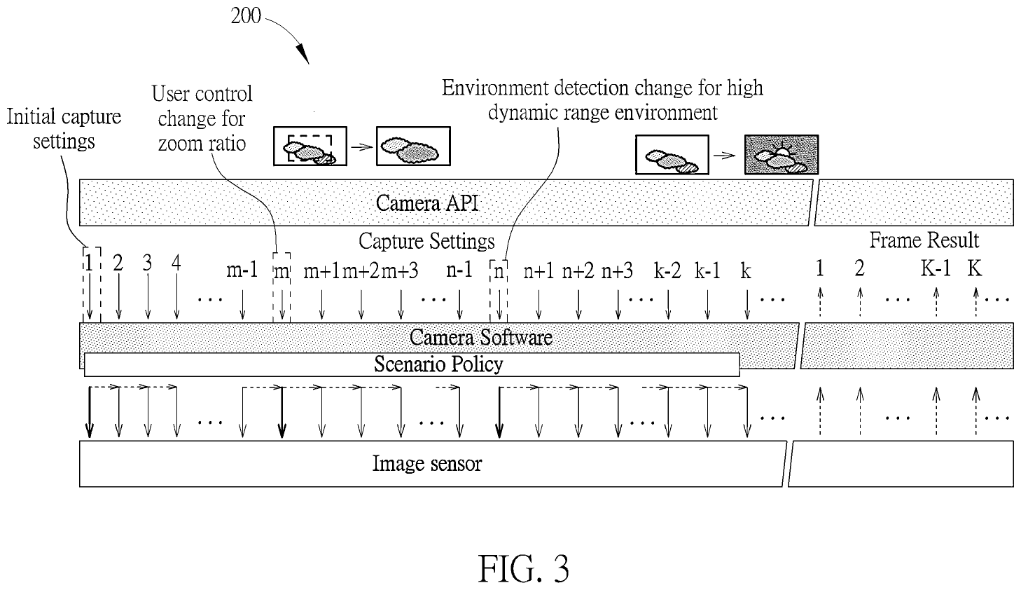

FIG. 3 depicts an embodiment of the non-frame-by-frame control camera system 200 with demonstration of changes in capture settings and frame results. The illustration highlights three pivotal moments that trigger recalculations of control parameters. The process begins at Frame 1 with the initiation of capture settings, where the camera system 200 performs its initial calculation for control parameters. This set of control parameters remains in use until frame m, at which point a user-initiated change, specifically a zoom ratio adjustment, prompts a recalculation. The newly computed control parameters are then applied, for example, at frame m and subsequent frames (m+1, m+2, and so on). The camera system 200 continues with these settings until frame n, where an environmental shift (e.g., the detection of a HDR condition) triggers another recalculation of control parameters. The newly calculated control parameters are then implemented, for example, from frame n onward (n+1, n+2, and so on), until the next significant change occurs.

This adaptive approach demonstrates the efficiency of the camera system 200 in resource utilization. Instead of recalculating control parameters for every single frame, computations are performed only when meaningful changes are detected, either from user input or environmental factors. It significantly reduces the computational load compared to related frame-by-frame systems, leading to lower CPU usage and improved power efficiency—crucial benefits for mobile devices with limited battery life.

Despite this optimized control method, the camera system 200 captures frames continuously. While the camera software layer operates on this non-frame-by-frame basis, it is understood that the image sensor still functions or receives control (for example, control commands, requests or any other type operations for control) on a frame-by-frame basis, applying the most recently calculated control parameters to each captured frame. In other words, control operations (for example, control commands, requests or any other type operations for control) are generated on a frame-by-frame basis and transmitted to the image sensor.

On the other side, frame results represent the continuous output of the camera's capture process. Despite the optimized control parameter calculations, the camera system 200 maintains an uninterrupted sequence of frame results from frame 1 to frame k and beyond, demonstrating that the camera captures and processes every single frame without compromise.

These frame results directly correspond to the capture settings depicted, showing how the control parameters determined by the settings are applied to produce each frame. Between the key recalculation points (frames 1, m, and n), the frame results are likely to exhibit consistency in their characteristics, as the same control parameters are applied across multiple frames (for example, by generating control instructions with the same control parameters and sent them to the image sensor) until a new calculation is triggered. However, at these recalculation points, noticeable changes in the frame results may occur. For instance, after frame m where a zoom ratio change is implemented, the results might display a different field of view or magnification. Similarly, following frame n, where an HDR environment is detected, the results could show improved dynamic range and contrast handling.

The continuous stream of frame results underscores that the non-frame-by-frame control should not compromise the ability of the camera system 200 to produce steady output. It may maintain the same frame rate and continuity as a related camera system while adapting to changing conditions to ensure consistent or improved image quality. This adaptive quality, though not explicitly shown in the diagram, is a key feature of the disclosed camera system, allowing it to maintain optimal results even as capture conditions change.

In essence, the frame results in this system demonstrate how the non-frame-by-frame control method achieves a balance between consistent, high-quality output and optimized use of system resources. By intelligently applying control parameters across multiple frames and only recalculating when necessary, the camera system ensures that each frame result benefits from appropriate settings without the overhead of constant recalculation. This approach enables efficient, adaptive image capture that can respond to significant changes in user input or environmental conditions while maintaining a smooth, continuous stream of output frames.

By intelligently balancing responsiveness with efficiency, this non-frame-by-frame camera system ensures high-quality image capture while substantially reducing computational overhead. It achieves this by making informed decisions about when recalculations are truly necessary, based on significant changes in user input or capture conditions, rather than indiscriminately recalculating for every frame. The result is a more efficient camera system that maintains image quality while adaptive resource usage.

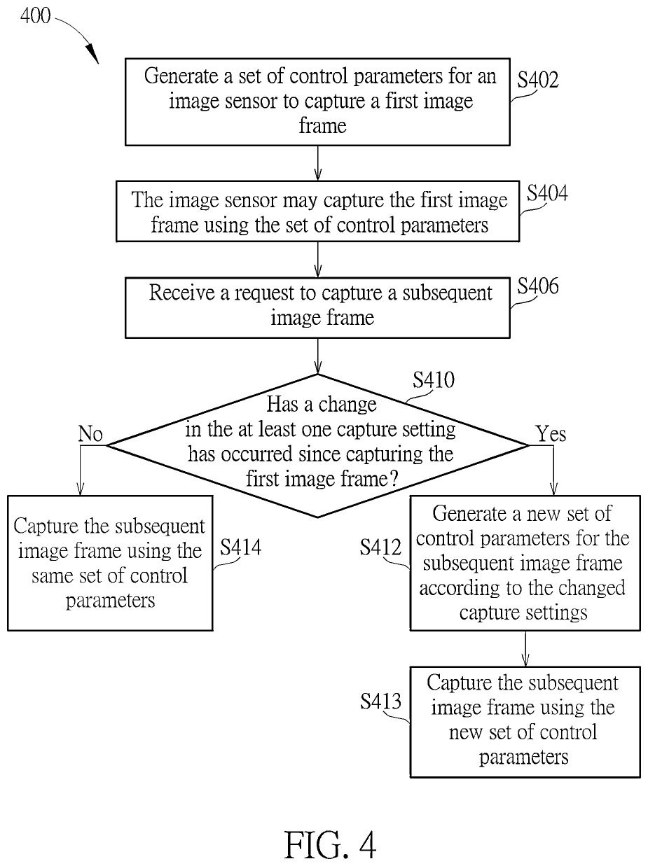

FIG. 4 depicts a flow diagram of a method 400 for the camera system 200, which summarizes the procedure described in previous paragraphs. The method 400 includes the following steps:
S402: Generate a set of control parameters for an image sensor to capture a first image frame, wherein the set of control parameters correspond to at least one capture setting;
S404: The image sensor may capture the first image frame using the set of control parameters;
S406: In some embodiments, a request to capture a subsequent image frame may be received;
S410: Determine whether a change in the at least one capture setting has occurred since capturing the first image frame; If so, proceed to S412; if not, proceed to S414;
S412: Generate a new set of control parameters for the subsequent image frame according to the changed capture settings;
S413: Capture the subsequent image frame using the new set of control parameters.
S414: Capture the subsequent image frame using the same set of control parameters.

It should be noted that an optional aspect of the non-frame-by-frame control camera system 200 is its efficient use of storage device (for example, a memory) to store and reuse control parameters. When the system calculates a set of control parameters for the first image frame, it would not discard this information after use. Instead, these parameters are stored in some form of storage device (for example, a memory), making a cache of control settings that can be quickly accessed/retrieved and applied to subsequent frames. This approach is particularly beneficial when capturing a series of images under stable conditions. For instance, when the camera system 200 needs to capture the next frame, instead of recalculating the entire set of parameters, it simply retrieves the previously determined settings from memory. This retrieval process is significantly faster and less computationally intensive than performing new calculations for each frame.

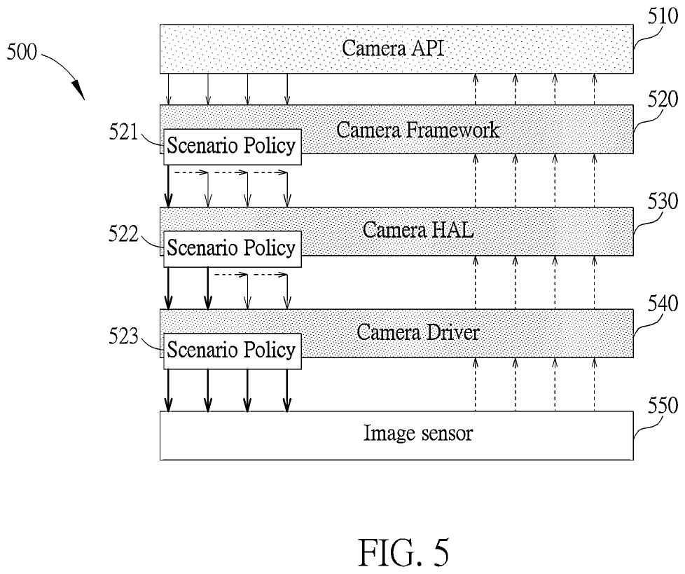

FIG. 5 depicts another non-frame-by-frame control camera system 500 according to the embodiments. The camera system 500 demonstrates a comprehensive view of the non-frame-by-frame control system within the context of typical layered camera software architecture. The camera system 500 comprises several distinct layers, starting with the camera API 510, the camera framework 520, camera HAL (Hardware Abstraction Layer) 530, camera driver 540, and an image sensor 550. The camera system 500 has distribution of scenario policies across multiple layers of this stack, specifically, the scenario policy 521 at the camera framework 520, scenario policy 522 within the camera HAL 530, and scenario policy 523 at the camera driver 540.

This hierarchical distribution of scenario policies 521-523 enables a sophisticated and flexible approach to optimization. Each scenario policy can be tailored to the specific responsibilities and capabilities of its associated layer, allowing for nuanced decision-making about when to recalculate control parameters. This layered strategy ensures that the non-frame-by-frame control concept is applied comprehensively throughout the camera system 500, adapting to various types of changes—from user inputs at higher levels to hardware-specific factors at lower levels.

The architecture's design implies a potential for coordination between these different Scenario Policies, allowing for optimal decision-making across the entire system. Importantly, this non-frame-by-frame system integrates seamlessly into the existing camera software architecture, enhancing its efficiency without requiring a complete structural overhaul. At the lowest level, the system maintains a direct interface with the camera hardware, ensuring precise control over physical components while benefiting from the optimized software control above.

The implementation of the non-frame-by-frame control camera system has a significant impact on the CPU usage, as measured in million cycles per second (MCPS).

In a related frame-by-frame control system (e.g., camera system 100), the software recalculates control parameters for every single frame. Using the example provided in the document of a video recording scenario with a frame rate of 30 FPS (frames per second), if each frame's calculation requires n MCPS, the total CPU usage per second would be 30×n MCPS. This constant recalculation, even when capture conditions remain stable, leads to unnecessarily high CPU usage and, consequently, increased power consumption.

In contrast, the non-frame-by-frame control system (e.g., camera system 200) significantly reduces this computational load. By recalculating control parameters only when necessary—such as when there are significant changes in user input or environmental conditions—the camera system dramatically cuts down on CPU cycles. For instance, in the same 30 FPS video recording scenario, if only two frames within that second require recalculation due to changing conditions, the CPU usage would be reduced to just 2×n MCPS. This represents a potential reduction in CPU cycles dedicated to parameter calculation for this specific task.

The optimization of MCPS usage brings multiple advantages to device operation and user interaction. By decreasing the overall CPU demand, this approach yields dual benefits: it minimizes power consumption and alleviates thermal stress on the device. These improvements contribute to a more efficient and sustainable performance profile, enhancing both the longevity of battery-powered devices and the comfort of users during extended usage periods.

It is important to note that while the reduction in MCPS for parameter calculation is substantial, the actual overall reduction in CPU usage will depend on various factors, including the complexity of other image processing tasks and the frequency of necessary recalculations. Nevertheless, the non-frame-by-frame control system presents a significant optimization in CPU usage, offering a more efficient approach to camera control that balances high-quality image capture with computational efficiency.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a graphics processing unit (GPU), a tensor processing unit (TPU), a neural network processing unit (NPU), a digital signal processor (DSP), an application specific integrated circuit (ASIC), a field programmable gate array (FPGA), other programmable logic devices (PLDs), discrete gate or transistor logic, discrete hardware components, any suitable combination thereof. Such hardware and apparatus shall be configured to perform the functions described herein.

A general-purpose processor may include, but is not limited to, a central processing unit (CPU), a microprocessor, or alternatively, any processor, controller, microcontroller or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a camera system, the method comprising:
generating, by a processor, a set of control parameters for an image sensor to capture a first image frame, wherein the set of control parameters correspond to at least one capture setting; and
determining, by the processor, whether a change in the at least one capture setting has occurred since capturing the first image frame, wherein a first subsequent image frame is captured using the set of control parameters for the first image frame when no change in the at least one capture setting has occurred.

2. The method of claim 1, further comprising when the change in the at least one capture setting has occurred:
generating, by the processor, a new set of control parameters for the image sensor to capture a second subsequent image frame.

3. The method of claim 1, wherein the at least one capture setting comprises zoom factor, exposure settings, ambient lighting conditions, capture mode, and/or scene content.

4. The method of claim 1, further comprising:
receiving, by the processor, the at least one capture setting.

5. The method of claim 1, further comprising:
storing the set of control parameters in a storage device; and
retrieving the set of control parameters from the storage device, such that the first subsequent image frame using the retrieved set of control parameters.

6. The method of claim 1, further comprising:
monitoring one or more capture settings in the set of capture settings;
comparing the monitored capture settings against predetermined thresholds or previous values; and
recalculating the set of control parameters when at least one of monitored capture settings exceeds corresponding predetermined threshold or deviates from a previous value by more than a specified amount.

7. The method of claim 1, further comprising:
transmitting, by the processor, a first request for the image sensor to capture the first image frame using the set of control parameters; and
transmitting, by the processor, a second request for the image sensor to capture the first subsequent image frame using the set of control parameters when no change in the at least one capture setting has occurred.

8. The method of claim 1, wherein the image sensor is configured to operate in a plurality of modes, each mode associated with different sensor parameters.

9. A camera system comprising:
a processor coupled to an image sensor, configured to:
generate a set of control parameters for the image sensor to capture a first image frame, wherein the set of control parameters correspond to at least one capture setting; and
determine whether a change in the at least one capture setting has occurred since capturing the first image frame, wherein a first subsequent image frame is captured by the image sensor using the set of control parameters for the first image frame when no change in the at least one capture setting has occurred.

10. The camera system of claim 8, wherein:
the processor is further configured to:
when the change in capture settings has occurred, generate a new set of control parameters for the image sensor to capture a second subsequent image frame.

11. The camera system of claim 9, wherein the at least one capture setting comprise zoom factor, exposure settings, ambient lighting conditions, capture mode, and/or scene content.

12. The camera system of claim 9, wherein the processor is further configured to receive the at least one capture setting.

13. The camera system of claim 9, further comprising:
a storage device coupled to the processor, configured to store the set of control parameters;
wherein the set of control parameters are retrieved from the storage device for the image sensor to capture the first subsequent image frame.

14. The camera system of claim 9, wherein the processor is further configured to:
monitor one or more capture settings in the set of capture settings;
compare the monitored capture settings with predetermined thresholds or previous values; and
recalculate the set of control parameters when at least one of monitored capture settings exceeds corresponding predetermined threshold or deviates from previous value by more than a specified amount.

15. The camera system of claim 9, wherein the processor is further configured to:
transmitting a first request for the image sensor to capture the first image frame using the set of control parameters; and
transmitting a second request for the image sensor to capture the first subsequent image frame using the set of control parameters when no change in the at least one capture setting has occurred.

16. The camera system of claim 9, wherein the image sensor further is configured to operate in a plurality of modes, each mode associated with different sensor parameters.
